(19) United States
(12) Patent Application Publication
(10) Pub. No.: US 2004/0197061 A1
(43) Pub. Date: Oct. 7, 2004

(54) Method of and apparatus for producing plastic optical fiber

(75) Inventors: Toru Ogura, Shizuoka (JP); Takahito Miyoshi, Shizuoka (JP)

Correspondence Address: BURNS DOANE SWECKER & MATHIS L L P, POST OFFICE BOX 1404, ALEXANDRIA, VA, 22313-1404, US

(73) Assignee: Fuji Photo Film Co., Ltd., Minami-ashigara-shi (JP)

(21) Appl. No.: 10/814,239

(22) Filed: Apr. 1, 2004

(30) Foreign Application Priority Data
Apr. 1, 2003 (JP) 2003-098188

(51) Int. Cl. G02B 6/02

(52) U.S. Cl. 385/123

(57) ABSTRACT

A perform formed of polymer is constructed of a center rod, first-sixth core tubes and a clad tubes, which are coaxially disposed in this order such that the refractive index may become lower gradually. Between the neighboring tubes and rod are formed gaps, and the atmospheres in the gaps are sucked. As the melt-drawing is made in the suction, the tubes and the rods adequately contacts to each other, and impurities generated in the melt-drawing are removed.

### BACKGROUND OF THE INVENTION

1. Field of the Invention

The present invention relates to a method of and an apparatus for producing plastic optical fiber, and more particularly relates to a method of and an apparatus for producing multi-step index optical fiber.

2. Description Related to the Prior Art

As having merits in easiness of processing and production, low price and the like., plastic optical member, the plastic optical member, compared with optical member of quartz having the same structure, is recently applied to several members, such as an optical fiber, an optical lens, an optical waveguide and the like. Especially the plastic optical fiber among these members is entirely made of plastic. Therefore the plastic optical fiber has merits in larger flexibility, smaller weight and more easy treatment and production as the optical fiber having large diameter, and the lower production cost than the quartz optical fiber, although having demerit in larger transmission loss. Accordingly, it is planned to use several sorts of the plastic optical fibers as transmitting mediums for a short distance, so far as the effect of the transmission loss is not so large.

The plastic optical fiber is constructed of a core whose main component is organic compounds in which polymer forms a matrix, and a clad composed of organic materials having different refractivity from the core. Especially, there is a plastic optical fiber of refractivity distribution type, in which the core has distribution refractivity from the center toward the outside. Recently, this type of the plastic optical fiber is more interested to use as the optical fiber having high transmission capacity (see, Japanese Patent Laid Open Publication No. 61-130904, and Japanese Patent No. 3332922), since the width for transmission of the optical signal can be made larger. Several the method of producing the optical member of the refractive distribution type are proposed, and for example, there is a method in which interfacial gelation is made to form a preform, and the preform is extended to produce the grated index plastic optical fiber (hereinafter, GI-POF).

By the way, the productivity of the GI-POF is low. A preform rod which is produced by performing the interfacial gelation has the refractive distribution, as the dopant molecules are diffused in the core polymerizing process. Accordingly, there are limits for the production period, the length and the thickness of the preform rod. In this view, the MSI-POF (multi-step Index type of the plastic optical fiber) whose main content is polymethylmethacrilate (hereinafter, PMMA) is proposed, for example in the Japanese Patent Laid Open Publications No. 10-111414, 10-133036, 11-52146. Note that plural layers having different refractivity is overlaid in the MSI-POF. The number of core layers in the core can be made larger such that the difference of refractivities among the core layers may be smaller to obtain the pseudo GI-POF.

As the method of producing the MSI-POF, Japanese Patent Laid-Open Publication No. 11-344623 teaches a following method. At first, the plural polymers having different refractivities are prepared. A pillar member for a center of the core is formed from one of the plural polymer. Then a first cylindrical member whose inner diameter is larger than the diameter of the pillar member and whose refractive index is smaller than the pillar member is formed. Further, a second cylindrical member whose inner diameter is larger than the outer diameter of the first cylindrical member, and whose refractive index is smaller than the first cylindrical member is formed. Thus, a plurality of the cylindrical members is formed and coaxially disposed with the pillar member according to an axis through centers of both circular bottoms, and they are heated collapsed by the inner cylindrical member or the pillar. Thus the preform is produced, and disposed such that the axis between the bottoms directed vertically. In this situation the preform is drawn along the axis to obtain the plastic optical fiber (hereinafter POF).

Further, in JP-A No. 11-344623, the pillar member and the cylindrical members are coaxially disposed with gaps. When the heating is made for producing the preform, the pressure in the gaps is regulated from 0.8 atm to 1.0 atm (ca., 0.08 MPa to 0.10 MPa) such that the circularity (=(minimal outer diameter)/(maximal outer diameter)) may be almost that of circle. Further, the humidity (relative humidity) and the oxygen concentration is regulated at most 1% in order to prevent the interfacial irregularity which is caused by voids generated on the interface or oxidization of the raw material.

However, as the MSI-POF has plural layers having different refractivity, the number of the interface must be large. Therefore, in the production of the preform of the MSI-POF, it is necessary that the void may not generate on the interface between cylindrical tubes corresponding the layers. Accordingly, the tubes are previously produced, and thereafter the tubes are closely disposed to the neighboring tube. Thereby, the surface of the tube is often damaged to form scratch, which causes an interface irregularity of the produced optical fiber. The improvement of the method is necessary in this point. Further, the number of the layers in the MSI-POF is made larger in order to increase the optical property. In this case, it becomes more difficult to improve the situation of the interface.

In the sucking method in which the pressure in the gap is decreased, as described in JP-A No. 11-344623, a unheated portion of the preform is often collapsed. Further, although it is preferable to adjust the humidity and the oxygen concentration, it is hard to adjust them in the low pressure. For the adjustment, the large system is often necessary.

Further, the optical fiber is also produced in the multi-layer extrusion method in which the plural layers of the MSI-POF are simultaneously formed. However, in this method, the extrusion machine becomes larger and the extrusion machine is hard to set. In order to vary the properties of the MSI-POF, the materials and the producing conditions are changed. Accordingly, the setting of the extrusion machine and the member thereof must be changed, and the production cost of the several sorts of the MSU-POF becomes high. Further, the plural layers are simultaneously extruded in this method. When one of the plural layers is damages, the entire of the produced preform or the POF is abolished. Therefore, the loss of the material is large.

### SUMMARY OF THE INVENTION

An object of the present invention is to provide a method of and an apparatus for easily producing a plastic optical fiber of multi-step index type in which a transmission capacity is good, a resistance to most heat is improved, and balanced improvement of several characters and properties is made.

In order to achieve the object and the other object, in a method of producing a plastic optical fiber, first-N^{th} tubes formed from plastic are coaxially disposed to construct a preform. The first tube is positioned innermost, and the N^{th} tube is positioned outermost. Then while the preform is heated, the melt-drawing thereof is performed, so as to obtain the plastic optical fiber. The refractive indexes are different between the first-N^{th} tubes.

In a preferable embodiment, a pillar rod made from plastic is disposed inside the first tube.

In the preferable embodiment of the present invention, the plastic optical fiber is constructed of a core and a clad. The core of the plastic optical fiber is formed from the first-(N−1)^{th} tubes, and the clad is formed from said Nth tube.

An apparatus for producing a plastic optical fiber from a preform in which plural tubes are coaxially disposed. The apparatus for producing the plastic optical fiber includes a sucking device for sucking atmospheres in gaps formed between the neighboring tubes, and a heating device for heating the preform. A melt-drawing device of the device of producing the practice optical fiber preforms the melt-drawing of the melted preform.

According to the method of and the apparatus for producing the plastic optical fiber of the present invention, the plastic optical fiber of the multi-step index type that has a good transmission capacity and an excellent resistance to most heat.

### BRIEF DESCRIPTION OF THE DRAWINGS

The above objects and advantages of the present invention will become easily understood by one of ordinary skill in the art when the following detailed description would be read in connection with the accompanying drawings.

FIG. 1 is a sectional view of a device for producing a tube used for a plastic optical fiber;

FIG. 2 is a schematic diagram of production line of the tube use for the plastic optical fiber;

FIG. 3 is a formation cylinder used in the production line;

FIG. 4 is an explanatory view illustrating a situation when a preform is drawn into the plastic optical fiber;

FIG. 5 is a plan view of a bottom of the preform;

FIG. 6 is a sectional view of the preform set to an adapter;

FIGS. 7a-7d are explanatory views illustrating a situation when the drawing of the preform is started;

FIG. 8 is a plan view of a bottom of the plastic optical fiber;

FIG. 9 is a graph illustrating a property of the plastic optical fiber;

FIGS. 10a-10c are graphs illustrating refractive index between neighboring layers in a core of the plastic optical fiber;

FIG. 11 is a schematic diagram of coating line for coating the plastic optical fiber with a coating layer.

### PREFERRED EMBODIMENTS OF THE INVENTION

The polymerizable components used for producing the optical fiber will be explained, at first. Then, the explanations for the producing method of an optical fiber will follow.

(Core)

The monomer used for preparing the polymer in the core of the optical fiber is preferably a material which is transparent in the wave length range of the transmitted optical beam and is easily processed. For example, there are (meth)acrylic acid esters [(a) (meth)acrylic esters without fluoride; (b) (meta)acrylic esters containing fluoride], (c) styrene type compounds, (d) vinyl esters, and the like. The core can be formed from one sort of polymer (including homopolymer composed of one sort of the monomers and copolymer composed of at least two sorts of the monomers), or from a mixture of two sorts of the polymers (including homopolymers and copolymers). Among them, (meth)acrylic acid esters can be used as a polymerizable monomer.

According to the polymerizable monomer, concretely, in (a) (meth)acrylic esters without fluoride, there are methyl methacrylate; ethyl methacrylate; isopropyl methacrylate, tert-butyl methacrylate; benzyl methacrylate, phenyl methacrylate; cyclohexyl methacrylate; diphenylmethyl methacrylate; tricyclo [5.2.1. 0^{2,6}] decanyl methacrylate; adamantyl methacrylate, isobonyl methacrylate, methyl acrylate; ethyl acrylate; tert-butyl acrylate; phenyl acrylate and the like. In (b) (meth)acrylic esters with fluoride, there are 2,2,2-trifluoroethyl methacrylate; 2,2,3,3,-tetrafluoro propyl methacrylate; 2,2,3,3,3-pentafluoro propyl methacrylate; 1-trifluoromethyl-2,2,2-trifluoromethyl methacrylate; 2,2,3,3,4,4,5,5-octafluoropentyl methacrylate; 2,2,3,3,4,4,-hexafluorobutyl methacrylate and the like. Further, in (c) styrene type compounds, there are styrene; α-methylstyrene; chlorostyrene; bromostyrene and the like. In (d) vinylesters, there are vinylacetate; vinylbenzoate; vinylphenylacetate; vinylchloroacetate; and the like. However, the polymerzable monomers are not restricted in them. Preferably, the content of the monomers is selected such that the refractivity of the homopolymer or the copolymer in the core may be higher than that in the clad. Note that the content of the polymers may be different between the layers of the core. In this case, it is preferable that the polymers in the neighboring layers have high affinity in view of the solubility parameter. Thus the interfacial irregularity between the neighboring layers hardly occurs. Further, when the POF is used for near infrared ray, the C—H bonds in the POF cause the absorption loss. Accordingly, the hydrogen atom on the C—H bond is substituted by the heavy hydrogen or fluorine in the polymer, and the core is formed from the polymers after the substitution treatment. For example, Japanese Patent Publication No. 3332922 teaches that the core is formed of deuteriated polymethylmethacrylate (PMMA-d8), polytrifluoroethylmethacrylate (P3FMA), polyhexafluoro isopropyl-2-fluoroacrylate (HFIP2-FA) and the like. Thus the wave length range of the transmitting light, in which the transmission loss occurs, can be shifted in the large wave length area. Thus the loss of the transmitting light is reduced. Note that when the polymer to be used for the optical fiber is prepared from the monomers, it is preferable to remove the impurities and foreign materials before polymerization such that the transparency may be kept at least the predetermined grade after the polymerization.

Further, there are polymers to which are polymerized acrylate components having aliphatic cyclic hydrocarbon groups or branching hydrocarbon groups on the side chain. Such polymers is easily damaged and has smaller drawing properties drawn than PMMA. When those polymers are used, the fluctuation of the diameter of the core becomes larger, and the core is broken by drawing. Accordingly, the co-polymerization of the polymers with the materials having flexibility is made or the fluorine resins are used as the clad or the coating, so far as the properties are at least the predetermined ones. Thus the optical fiber becomes hardly damaged.

(Clad)

The transmitting light is entirely reflected on the interface between the core and the clad. Therefore the clad has the smaller refractivily than the core, is amorphous, and preferably has high adhesive property to the core. In the present invention, the materials for forming the clad are selected such that these conditions may be satisfied. The core is positioned in an inner side of the cylindrical clad. Especially, when the interface between the core and the clad becomes in the irregular situation, the optical property of the optical fiber becomes lower. Accordingly, it is preferable in view of the optical property, mechanical property, and the uniform productivity that an inner surface of the clad for contacting to the core is formed from the same polymers. Further, sometimes the polymer is selected and then the inner surface has irregular situation to the clad, or otherwise there are inadequate cases for production. In these cases, one more layer may be provided between the core and the clad. Further, as the transmittance property is decreased by absorbing the moisture, it is preferable to reduce the penetration of the water into the core. Therefore, the materials of the clad may be the polymers having low absorption aggregate of water. As such copolymer, there are MMA-BzMA and the like.

The preferable materials for the clad are excellent in toughness, the resistance to moisture and heat. In these view points, it is preferable that the clad is formed from the homopolymer or the copolymer composed from the monomer containing fluorine. A preferable monomer is vinylidene fluoride. Preferably, the polymer used for the clad is composed from at least one sort of the monomers containing at least 10 wt. % of vinylidene fluoride.

When the polymer as the materials of the optical fiber are prepared from the polymerizable components, it is preferable that the polymerizable components contain the following additives with the polymerizable monomer.

(Polymerization Initiator)

The polymerization initiators can be selected in accordance with the monomers to be used or the polymerization method. There are peroxide compounds [for example, benzoil peroxide (BPO); tert-butylperoxy-2-ethylhexanate (PBO); di-tert-butylperoxide (PBD); tert-butylperoxyisopropylcarbonate (PBI); n-butyl-4,4-bis(tert-butylperoxy)valerate (PHV); and the like], azo compounds [for example, 2,2′-azobisisobutylonitryl; 2,2′-azobis(2-methylbutylonitryl); 1,1′-azobis(cyclohexane-1-carbonitryl); 2,2′-azobis(2-methylpropane); 2,2′-azobis(2,3-dimethylbutane); 2,2′-azobis(2-methylhexane); 2,2′-azobis(2, 4-dimethylpentane); 2,2′-azobis(2,3,3-trimethylbutane); 2,2′-azobis(2,4,4-trimethylpentane); 3,3′-azobis(3-methylpentane); 3,3′-azobis(3-methylhexane); 3,3′-azobis(3,4-dimethypentane); 3,3′-azobis(3-ethylpentane); dimethyl-2,2′-azobis(2-methylpropionate); diethyl-2,2′-azobis(2-methylpropionate); di-tert-butyl-2,2′-azobis(2-methylpropionate); and the like] and the like. Also, two or more of those may be combined for use.

(Chain Transfer Agent)

Preferably, the polymerizable components contain chain transfer agents which is mainly used for controlling molecular weight of the polymer. In this case, when the monomer is composed from the polymerizable monomers, then the speed and the degree of polymerization can be regulated with use of the chain transfer agent, and thus the molecular weight of the polymer is controlled to the predetermined value. Further, when the molecular weight of the polymer is controlled, the mechanical property for drawing to produce the optical fiber is set to a predetermined range. Thus the productivity becomes higher. Sorts and amount of the chain transfer agent is selected in accordance with the sorts of the polymerizable monomers. The chain transfer coefficient of the chain coefficient agent to the respective monomer is described, for example, in “Polymer Handbook, 3^{rd} edition”, (edited by J. BRANDRUP & E. H. IMMERGUT, issued from JOHN WILEY&SONS). Otherwise, the chain transfer coefficient may be calculated through the experiments in the method described in “Experiment Method of polymers” (Takayuki Otsu and Masayoshi Kinoshita, issued from Kagaku-Dojin Publishing Company, Inc, 1972).

In the chain transfer agent, there are alkylmercaptans [for example, n-butylmercaptan; n-pentylmercaptan; n-octylmercaptan; n-laurylmercaptan; tert-dodecylmercaptan; and the like], thiophenols [for example, thiophenol; m-bromothiophenol; p-bromothiophenol; m-toluenethiol; p-toluenethiol; and the like]. It is especially preferable to use n-octylmercaptan, n-laurylmercaptan, and tert-dodecylmercaptan in the alkylmercaptans. Further, the hydrogen atom on C—H bond may be substituted by the heavy hydrogen atom and fluorine atom in the chain transfer agent. Note that plural sorts of the chain transfer agents may be used simultaneously, and the sorts are not restricted in the above substances.

(Refractive Index Control Agent)

In the present invention, a refractive index control agent may be contained in the polymerizable material so as to control the refractive index. When the refractive index control agent is used, the refractive index can be controlled in each layer. Accordingly the core having predetermined refractive index distribution may be manufactured. Note that when the refractive index control agent is not used, plural polymerizable monomers are contained at the predetermined content. Thus the content distribution of the monomers are provided through the entire layers of the core. Thus the core has the refractive index distribution. Note that when the clad is made from the polymerizable monomers, then the refractive index control agent may be used for easy control of the refractive index.

The refractive index control agent is called also dopant, which has different refractive index from the polymerizable monomers in which the refractive index control agent is added. Preferably, the difference of the refractive index is at least 0.005. When the polymer contains the dopant, the refractive index becomes higher. The increase of the refractive index of the polymer is preferably at least 0.001 in comparison of the polymers produced from the monomers as described in Japanese Patent Publication No. 3332922 and Japanese Patent Laid-Open Publication No. 5-173026. The materials selected as the refractive index control agent may be stable also under existence of the polymer and the situation of the polymerization of the polymerizable monomer of the above materials. The dopant may be polymerizable materials. In this case, it is preferable that the refractive index of the copolymer in which the dopant is also polymerized is higher than the polymer in which the dopant is not polymerized.

The dopants as described in the JP-B No. 3332922 and JP-A 11-142657 are, for example, benzyl benzoate (BEN); diphenyl sulfide (DPS); triphenyl phosphate (TPP); benzyl n-butyl phthalate (BBP); diphenyl phthalate (DPP); biphenyl (DP); diphenylmethane (DPM); tricresyl phosphate (TCP); diphenylsulfoxide (DPSO); derivatives of diphenylsulfide; derivatives of dithiadine; and the like. According to derivatives of diphenylsulfide and derivatives of dithiadine, one or plural sorts is adequately selected from the materials D1-D11 shown in “Chemical Formulae”. Especially preferable dopants are BEN, DPS, TPP, DPSO, derivatives of diphenylsulfide and derivatives of dithiadine. It is to be noted in these dopants that hydrogen atom may be substituted for heavy hydrogen atom. In this case, the transmittancy of the produced optical fiber in the large wave length range can be made higher. Further, as the polymerizable components, there are tribromo phenylmethacrylate and the like. When the refractive index control agent to be used is the polymerizable components, the polymerizable refractive index control agent and the polymerizable monomers are polymerized to produce copolymer, and the refractive index is controlled in each layer. Accordingly, although the control of several properties (especially optical property) is more difficult, the control of the refractive index is more easily made than GI-POF. Further, in this case, there is a merit of the heat resistance.

The refractive index of the optical member is controlled by changing of the content and the distribution of the refractive index control agent. The amount of the refractive index control agent to be added is determined in accordance with the way of use and the members to be combined. The plural sorts of the refractive index control agent may be added and the sorts may be different between the layers.

Chemical Formulae

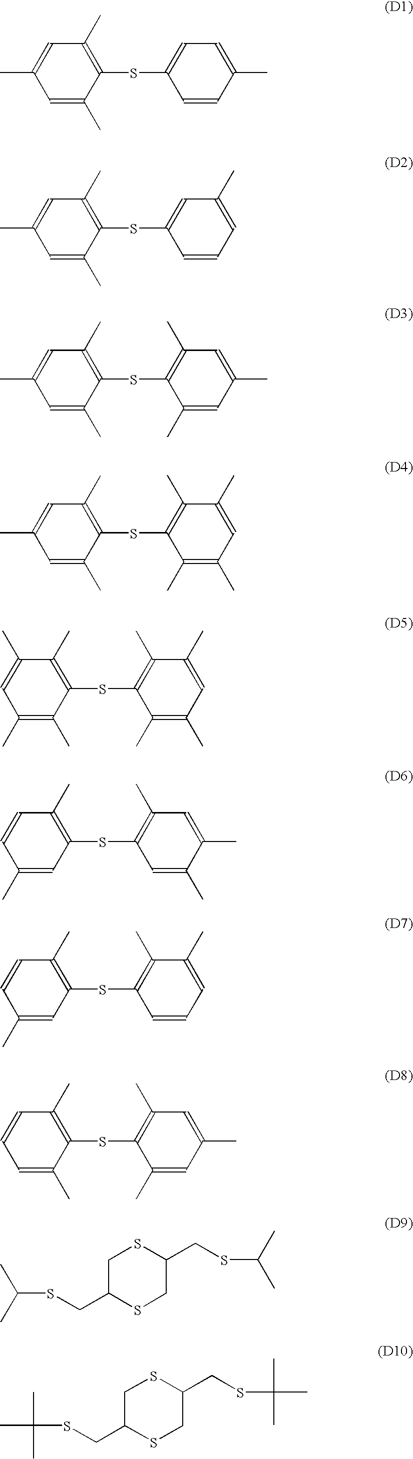

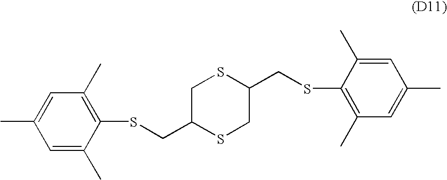

(Other Additives)

Other additives may be contained in the core and the clad so far as the transmittance property is not decreased. For example, the stabilizers may be added for increasing the resistance to climate and the durability. Further, induced emissive functional compounds may be added for amplifying the optical signal. When these compounds are added to the monomers, these compounds are excited by the weak signal light to generate an excitation light, and the signal light is amplified. The POF can be used as an optical fiber amplifier. These additives may be polymerized with the monomers to compose the copolymer, which is contained the core and the clad.

<Method of Producing Plastic Optical Fiber>

An explanation of a method of producing the multi-step index type of the plastic optical fiber will be made, now. It is to be noted, however, that the present invention is not restricted in the following description. The method of producing the plastic optical fiber includes a first process for preparing the preform and a second process for heating and drawing the preform to form the POF. In the first process, the polymerization of the polymer produced from the polymerizable components or the melted thermoplastic resin is made to form the pillar member (hereinafter rod) or a center core to be disposed at a center of a preform, core tubes which are coaxially disposed around the rod, and clad tubes used for forming the clad of the optical fiber. When the coaxial disposition of the core tubes and the clad tubes around the rod is complete, the preform is obtained. In the second step, the melt-drawing of the preform is performed so as to produce the POF.

(Production of Polymer)

When the clad tube, the core tube and the rod are made of polymerizable components, the preferable contents of the polymerizable components are different between the sorts thereof, and therefore cannot be readily determined. However, usually, the content of the polymerization initiators is preferably 0.005 to 0.5 wt. % to the polymerizable monomers, and particularly 0.01 to 0.5 wt. %. The content of the chain transfer agent is preferably 0.10 to 0.40 wt. % to the polymerizable monomer, and particularly 0.15 to 0.30 wt. %. Further, the content of the refractive index control agent in the polymerizable monomers for the rod and the core tube is preferably 1 to 30 wt. %, and particularly 1 to 25 wt. % to the polymerizable monomers. Especially, as the core tubes have respective refractive indexes, the content of the refractive index control agent should be determined for each core tube.

When the tubes are produced in melt extrusion method, the viscosity of the melted polymer must be adequate. And as the viscosity is related to the molecular weight, the molecular weight is used instead of the viscosity, and the averaged molecular weight which is easily measured is used as the molecular weight. The adequate averaged molecular weight is in the range of 10,000 to 1,000,000.

Further, it is preferable that the averaged molecular weight is determined also in view of the smooth drawing. The averaged molecular weight is preferably in the range of 10,000 to 1,000,000, and especially 30,000 to 500,000. Furthermore, the molecular weight distribution (MWD=averaged molecular weight/numeral molecular weight) influences on the drawing. Even when the small amount of the polymers of extremely large molecular weight is contained, the drawing is not made smoothly, or becomes impossible. The MWD is preferably at most 4, and especially at most 3.

The core tube and the rod are produced in a tube production method, namely a rotate-polymerization method in which the core tubes and the clad tube are directly produced from monomers in the polymerization. An example of the rotate-polymerization method is disclosed in the JP-B No. 3332922. In this publication, the polymerizable components (polymerizable monomers) used for forming the rod and the clad tube are supplied into a cylindrical polymerization tank, and those for forming the core tube are supplied into a cylinder tube which is formed of a fluoride resin and surrounded with a cylindrical tank. Then both of the polymerization tank and the cylinder tube are rotated around the axis through two bottoms thereof. Preferably, the rotation is made in the situation in that the axis extends horizontally. In the rotation, the polymerization of the monomers are made. In this rotate-polymerization method, the produced tubes can be formed to have two layers. In this case, the number of the core and clad tubes can be reduced, and the optical tube to be obtained can have the refractive index distribution to keep the effects of the present invention.

Preferably, the polymerizable components filtrated with a filter before the supply into the polymerization tank, so as to remove the dusts. Further, as described in Japanese Patent Laid-Open Publication No. 10-293215, the prepolymerization or the adjustment of the viscosity of the monomers can be made for easy treatment before the supply into the polymerization tank, so far as the quality of the optical filter does not become worse and the pre- and posthandling are not roughly made. Thus the period for polymerization in the tank can be made shorter.

The polymerization temperature and the polymerization period are different between the monomers and the polymerization initiators to be used. Usually, the preferable polymerization temperature is 60° C. to 150° C., and the preferable polymerization period is 5 hours to 24 hours. Thereby, as shown in Japanese Patent Laid-Open Publication No. 8-110419, the prepolymerization of the prepolymerizable components is made to increase the viscosity, and thus the period for polymerization may be made shorter.

Further, when the polymerization tank is deformed in the rotation, the tubes to be obtained has irregular form. Accordingly, it is preferable that the polymerization tank is metal tube and or a glass tube that has enough rigidity. When the tubes are obtained in the polymerization of the polymerizable components, the monomers and the polymerization initiators do not have to remain. Accordingly, the obtained tube may be heated at the temperature higher than the polymerization temperature to completely perform the chemical reaction of the monomer and the polymerization initiator, and otherwise the components which are not polymerized may be removed after the tube is obtained.

Further, pellets or powders of the polymer (preferably fluorine polymer) are fed into a cylindrical tank, and both ends of the cylindrical tank are closed. Then the cylindrical tank is rotated in the situation that the axis through both bottoms extends horizontally. Thereby the polymer is heated to at least the melting point and melted to produce the tubes. In this case, in order to prevent the deterioration, oxidization, or heat oxidization of the polymer, it is preferable that the production of the tube may be made in the nitrogen gas or inert gas (for example, argon), and that the polymer is previously dried enough.

Otherwise, in the case of the formation of tubes in the melt extrusion, the prepared polymer is melted and fed into the die. Thus the tubes can be formed to have the predetermined shape (cylindrical shape in this embodiment) by using the extrusion. As the melt-extruding machine used thereby, there are an innersizing die type and an outer dies type.

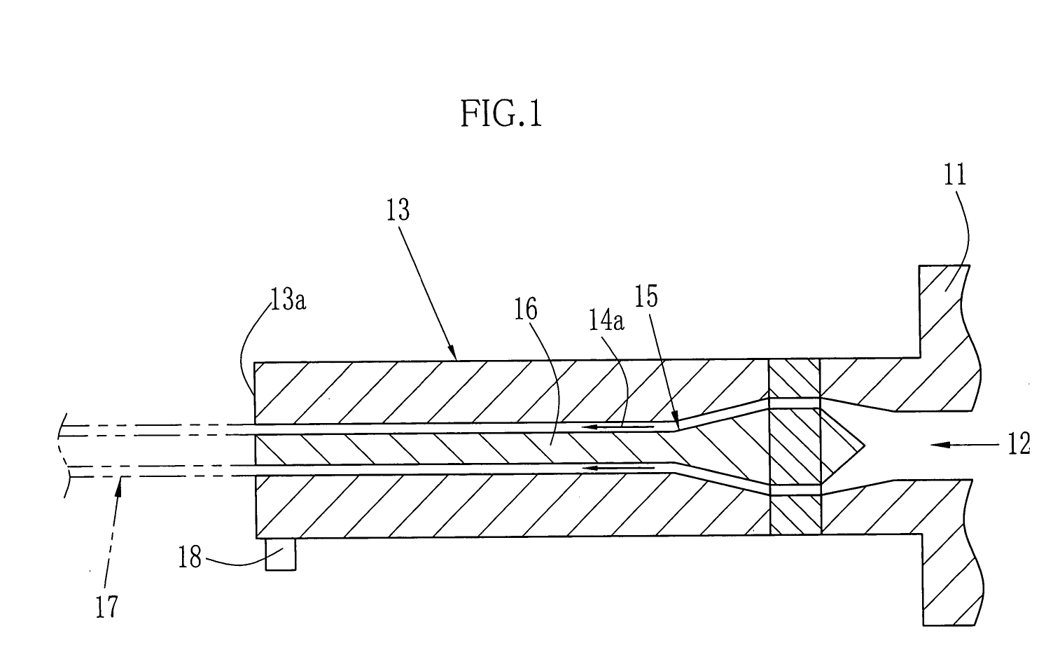

In FIG. 1, the melt-extruding machine of the innersizing dies type is used for producing the clad tube. Note that the core tube can be produced in the same condition as described below.

The melt-extruding machine of the innersizing dies type has a main body 11. A polymer 12 is extruded from the main body 11 into a die body 13 of a dies by a screw extruder (not shown). Inside the die body 13 is disposed a guide 15 or gate for guiding the polymer 12 in a path 14a. The polymer 12 is guided with the guide 15, passes through the path 14a between the die body 13 and an inner rod 16 or mandrel, and is discharged as a cylindrical tube 17 from an exit 13a or orifice of the die. The discharging speed of the cylindrical tube 17 is not especially restricted. However, it is preferably 1 cm/min to 100 cm/min, in view of productivity and for keeping the uniform shape. Note that the cylindrical tube 17 is used as the clad tube and the core tube by setting the inner and outer diameters.

In the die body 13, a heating device is provided for heating the polymer 12. For example, one or two of the heating device may be disposed along the path 14a of the polymer 12 so as to cover the die body 13. As the heating device, there are devices in which steam, heat medium oil, and an electric heater are used. Otherwise, a thermal sensor 18 is attached to the exit 13a to measure the temperature of the exit 13a of the die, and the data of the measurement is used for regulation of the temperature at the exit 13a. It is preferable that the temperature is less than the glass transition temperature of the polymer 12 for forming the cylindrical tube 17 uniformly. Further, it is preferable that the temperature of the cylindrical tube 17 is at least 40° C. In this case, the deformation of the tube caused by sudden change of the temperature is prevented. In order to control the temperature of the cylindrical tube 17, a cooling device (not shown) may be provided with the die body 13. As the cooling device, there are devices in which liquid materials (for example, water, non-freezing fluid, oil and the like) and an electric cooler and the like are used. Further, the die body 13 may be cooled in natural cooling or by dissipating heat. When the heating device is provided with the die body 13, then the cooling device is disposed preferably in the downstream side from the heating device.

In the core tube used in the present invention, the generation of the interfacial irregularity during melt-drawing must be prevented. Accordingly, the outer surface and the inner surface of the core tube should be excellent in smoothness. In the innersizing dies type, the core tube having smooth surfaces are easily produced. Therefore, in comparison with the outer dies type as described below, it is preferable that the core tube used in the present invention is formed with use of innersizing dies type. As an outer surface of the clad tube is not an optical waveguide, the smoothness of the outer surface is often less necessary than that in the case of the core tubes. However, when the POF is used as an optical transmitting member, the POF is coated with a coating layer to form a primary coated optical fiber. When the coating layer is formed, the less smoothness of the periphery or the outer surface of the clad tube causes the microbending. In the present invention, the averaged surface roughness (SRa) per unit area of the inner and outer surfaces of the core tubes and the inner surface of the clad tube is preferably 0.01 μm to 1 μm, and particularly 0.05 μm to 0.3 μm. The surface roughness of the outer surface of the clad tube is 0.05 μm to 1 μm.

In the above tube production method, the cylindrical tube 17 has a single layer, but may have plural layers. When the polymerization is made in the rotation of the polymerization tank, the cylindrical tube having the single layer is made and thereafter other polymerizable components are supplied in the polymerization tank to form a second layer. Otherwise, a multi-layer extruding die is used in the melt-extrusion method. Note that the control of several conditions is more difficult in the production of the cylindrical tube having the plural layers than the single layer. The adequate number of the layers is from 2 to 4. In these methods, the optical fiber can have the preferable refractive index distribution, although the number of tubes in the preform can be reduced.

Note that the rod as the center rod of the preform can be formed in a similar manner in the method of FIG. 1 or in the polymerization method. In this case, the polymer is fed out from the die body so such that the hollowness of the tube does not remain.

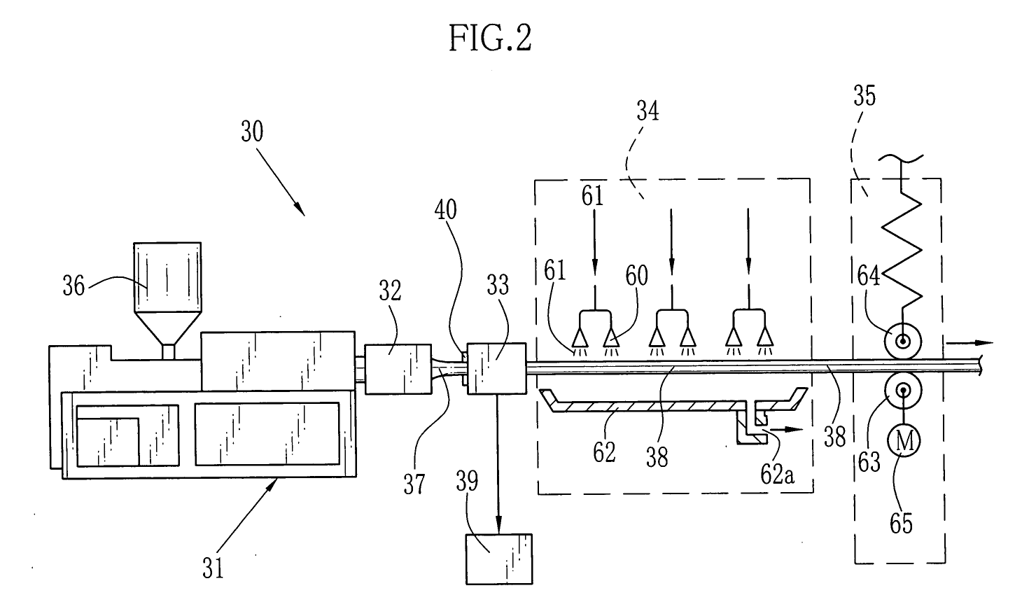

In FIG. 2, the rod is produced in a production line 30 with a melt-extruding machine 31 of the outer dies type, which includes a preliminary extruding die 32, a molding die 33 or forming die, a cooling device 34, a feeding device 35 and a hopper 36. A pellet of the polymer is supplied through the hopper 36 into the melt-extruding machine 31. In the melt-extruding machine 31, the polymer is melt and extruded to the molding dies 33 by the extruding dies 32. The extruding speed S is preferably 0.1≦S(m/min)≦10, particularly 0.3≦S(m/min)≦5.0, and especially 0.4≦S(m/min)≦1.0. In the present invention, however, the extruding speed S is not restricted.

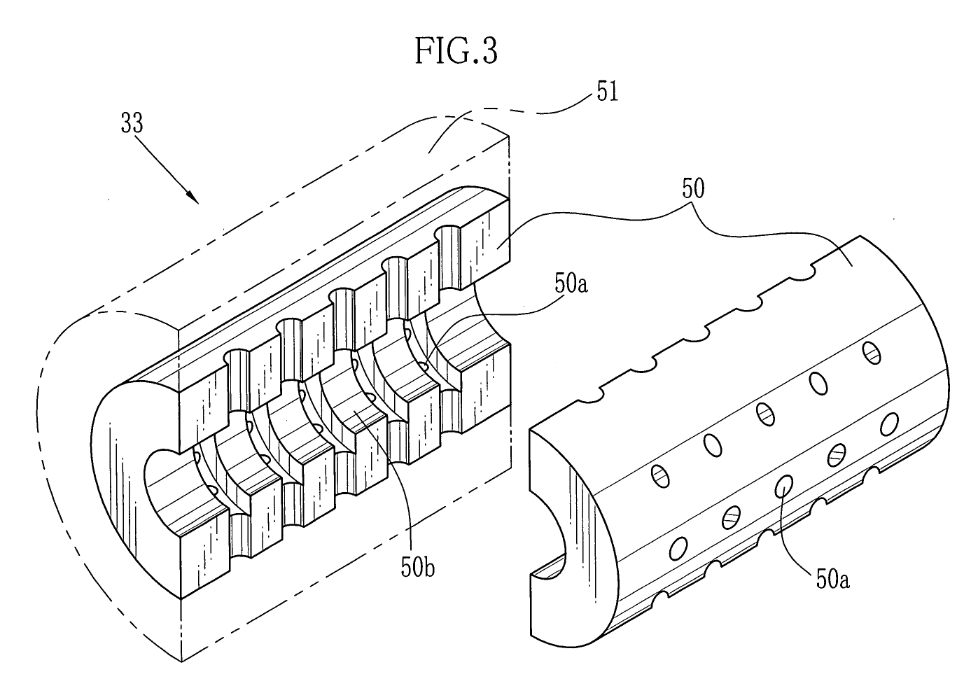

As shown in FIG. 3, the molding dies 33 includes a molding die tube 50. A melted polymer 37 passes through the molding tube 50 to obtain a pillar rod 38 (see, FIG. 2). In the molding tube 50, and suction holes 50a are formed. A decompression chamber 51 is provided outside the molding tube 50, and a vacuum pump 39 (see, FIG. 2) sucks to reduce the inner pressure of the decompression chamber 51. Thus the outer surface of the rod contacts to an inner surface 50b of the molding tube 50, and therefore the non-uniform shape of the outer surface of the rod 38 is restrained. Note that the preferable inner pressure of the decompression chamber is 20 kPa to 50 kPa. However, it is not restricted in this range. Note that a throat 40 (see FIG. 2) as a determining member for determining the outer diameter of the rod 38 may be attached at an entrance of the molding dies 33.

In FIG. 2, the rod 38 whose shape is adjusted in the molding dies 33 is fed to the cooling device 34. The cooling device 34 has plural nozzles 60, and a cool water 61 is discharged from the nozzles 60 to the rod 38. Then the rod 38 is cooled and solidified. The cool water 61 is received by a receiver 62, and discharged through an exit 62a. The rod 38 is fed out from the cooling device 34 by the feeding device 35. The feeding device 35 includes a drive roller 63 and a press roller 64. The drive roller 63 is connected with a motor 65 which drives the drive roller 63 and regulates the rotating speed of the drive roller 63. The press roller 64 is provided so as to confront to the drive roller 63, and biased to the drive roller 63 by a spring 64a such that the drive roller 63 and the press roller 64 nip the rod 38 to correct the position of the rod 38 with the positional irregularity. In this embodiment, the rotating speed of the drive roller 63 and the extruding speed of the melt-extruding machine 31 are adjusted, or the position of the rod is adjusted. Thus the generation of unevenness on the rod 38, especially on the outer surface of the rod 38 is reduced. Accordingly, the interfacial irregularity in the optical fiber to be produced is reduced.

Note that in the method explained with reference to FIGS. 2 & 3, the core tubes and the clad tubes can be produced in a similar manner. In this case, the extruding die 32 is exchanged to another one in which the melted polymer is extruded through a cylindrical path. However, in the outer die type, as the cylindrical tubes are formed and thereafter the outer diameter is adjusted by sucking, it is difficult to form rods without hollowness. Accordingly, as far as the expected refractive index distribution is provided in the optical fiber to be produced, rods without hollowness are formed with use of the outer dies type.

Preferably the outer surface of the rod has high smoothness such that the interfacial irregularity does not occur in the optical fiber. Therefore the core is easily produced with use of the outer dies type. The average surface roughness (SRa) in a standard size is preferably 0.01 μm to 1 μm, particularly 0.05 μm to 0.6 μm, and especially 0.05 μm to 0.3 μm.

(Method of Producing POF)

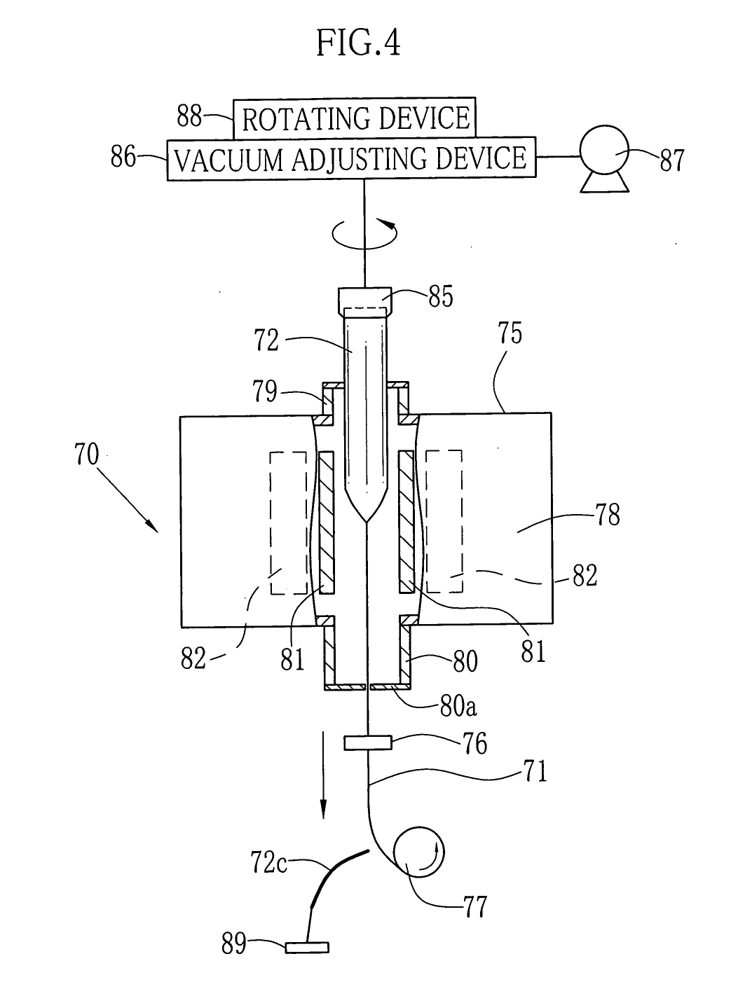

In FIG. 4, the preform 72 is drawn by the melt-drawing device 70 to produce the POF 71. The melt-drawing device 70 includes an oven 75 or furnace, a monitor 76 for monitoring the outer diameter of the drawn POF 71, and a winding device 77. Further, the oven 75 has a cover 78 an entrance portion 79, an exit portion 80, a cylindrical heating pipe 81 and a heater 82. In the heating pipe 81, the preform 72 is inserted, and the heater 82 is disposed outside the heating pipe 81, and heats the preform 72 through the heating pipe 81. Further, the upper side of the preform 72 is nipped by an upper adapter 85, to which an vacuum pump 87 is connected through a vacuum adjusting device 86 for regulating a vacuum degree in the oven 75. Further, the melt-drawing deice 70 is provided with a rotating device 88 for rotating the preform 72 during the drawing. The circularity of the POF 71 becomes higher by drawing the preform.

The heater 82 heats the preform 72 to perform the drawing. Usually, the preferable value thereof is 180° C. to 250° C. The drawing conditions including the drawing temperature is determined in accordance with the materials of the preform 72, the diameter of the preform, the predetermined diameter of the POF. For example, while the preform 72 is heated from the outer side, the thermal energy is smaller in the inner side than the outer side. Accordingly, as explained in detail in below, the glass transition temperature Tg of the tube in the inner side is low. In consideration of such situations, the preform 72 is drawn to the POF 71 while the drawing conditions are adjusted on the basis of the outer diameter measured with use of the monitor 76. Note that the preform can be coated with a protective layer for the protection and the reinforcement before the drawing.

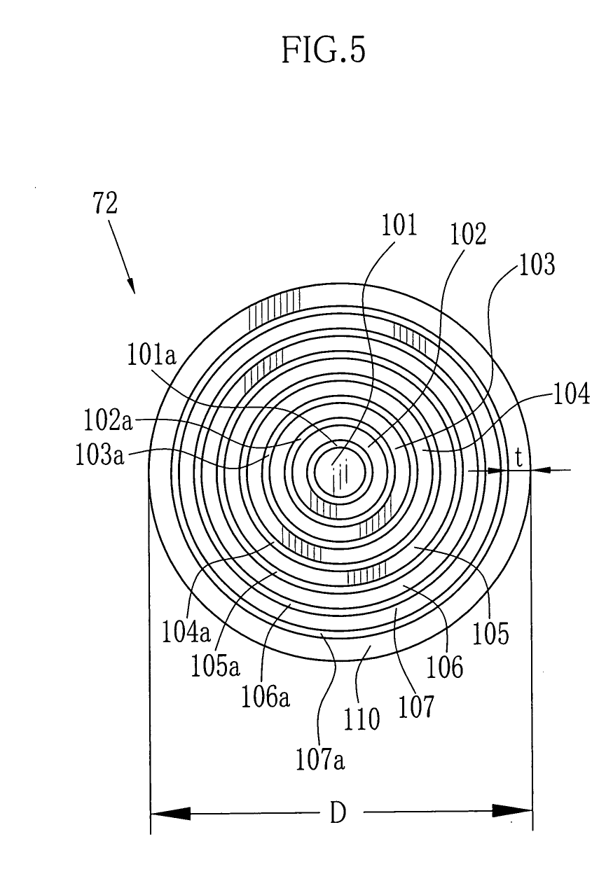

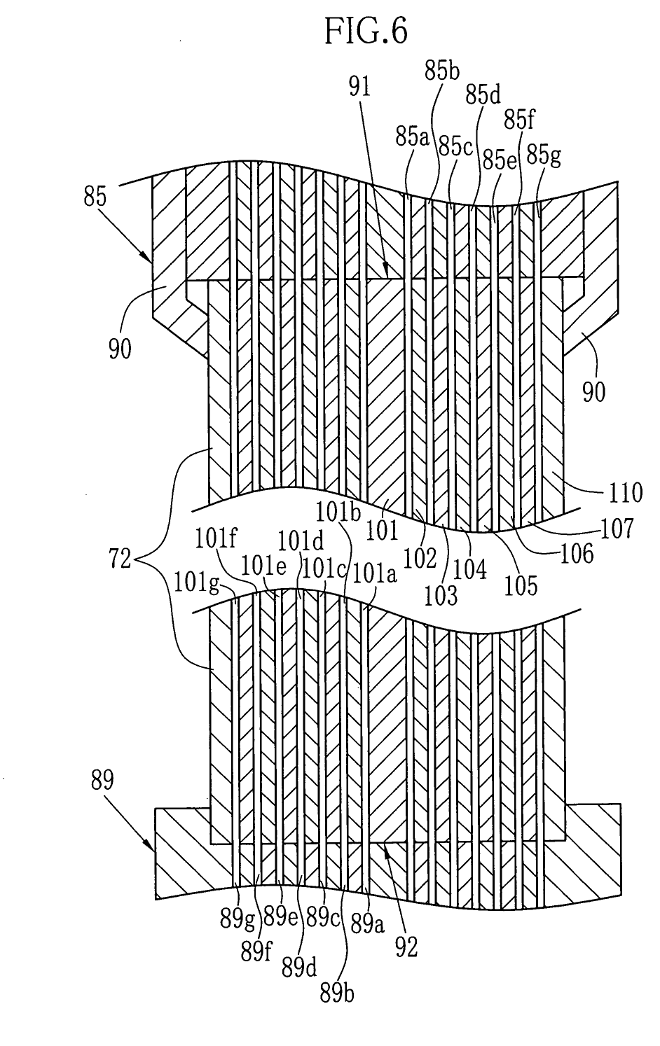

As shown in FIG. 5, the preform 72 is constructed of a center core rod 101, first-sixth core tubes 102-107, and a clad tube 110. The first-sixth core tubes 102-107 are coaxially disposed and produced such that the refractive index may become gradually smaller from the center rod 101 to the sixth core tube 107. Note that a center tube having the smaller outer diameter than the inner diameter of the first core tube 102 can be used instead of the center rod. In this case, suction is made during the melt-drawing such that the inner space of the center tube may be diminished. The clad tube is disposed so as to surround the sixth core tube (or the outermost core tube) 107. The first-sixth core tubes 102-107 are in a sequence of lowering the refractive index toward the periphery. Thus the center rod 101, the first-sixth core tubes 102-107, and the clad tube 110 form layers of the preform 72, and there are gaps 101a-107a (see, FIG. 6) among the center rod 101, the first-sixth core tubes 102-107 and the clad tube 110. These gaps are diminished while the shrinking of the preform is made. The methods therefor are, for example, the application of the outer pressure to the preform, the decompression in the gaps, and the like. However, when the decompressing is made in the present invention, the contact causing the damage is prevented, and therefore the irregular structure of the optical fiber hardly occurs. Further, the monomers often remain in the preform 72 under some of the polymerizing conditions. However, in the decompressing method, the remaining monomers are removed. Accordingly, the decompressing method is preferable in the present invention.

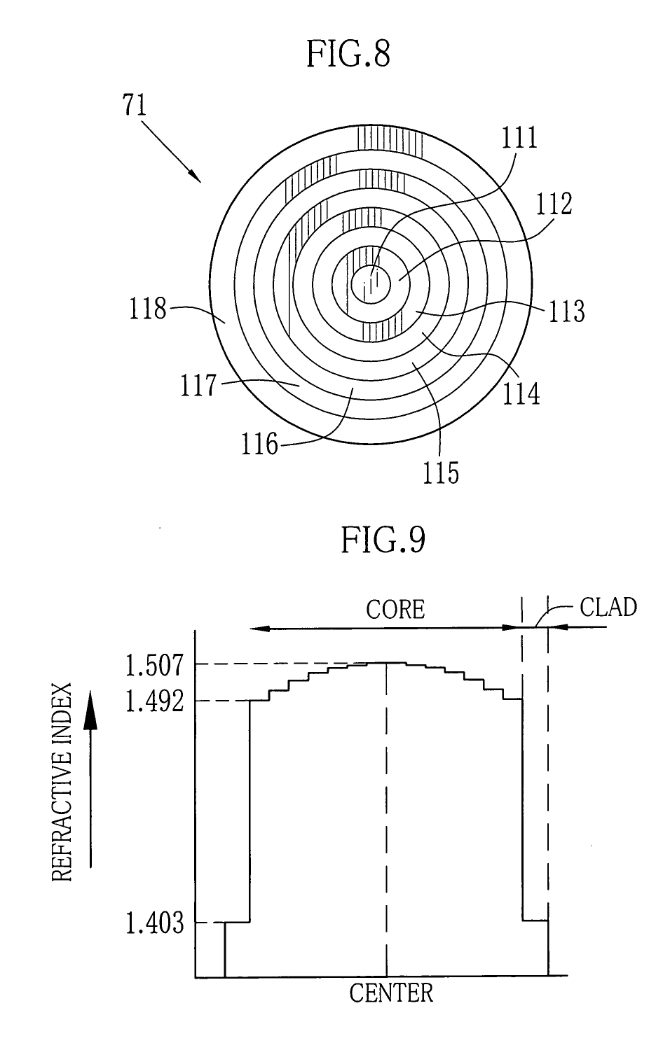

Further, a thickness tn including a rod thickness of the rod and a wall thickness of each tube can be smaller so far as the predetermined refractive index distribution of the POF may be provided for the POF 71. In view of the optical property and the productivity, the preferable thickness tn of each layer is 1≦tn(mm)≦20. The thickness tn of each rod and tubes can be determined when the refractive index distribution of the preform 72 is nearly squared distribution. In this case, the refractive index distribution of the POF 71 obtained from the preform 72 is also the nearly squared distribution. (see, FIG. 9) Further, the clad tube 110 may have plural layers in order to several effects, such as increase of mechanical strength, nonflammability and the like, and the outer surface of the clad tube 110 may be covered with a fluorine resin. The size of the preform depends on the thickness tn and the number of the plural layers. However, the present invention is not restricted in the above ranges.

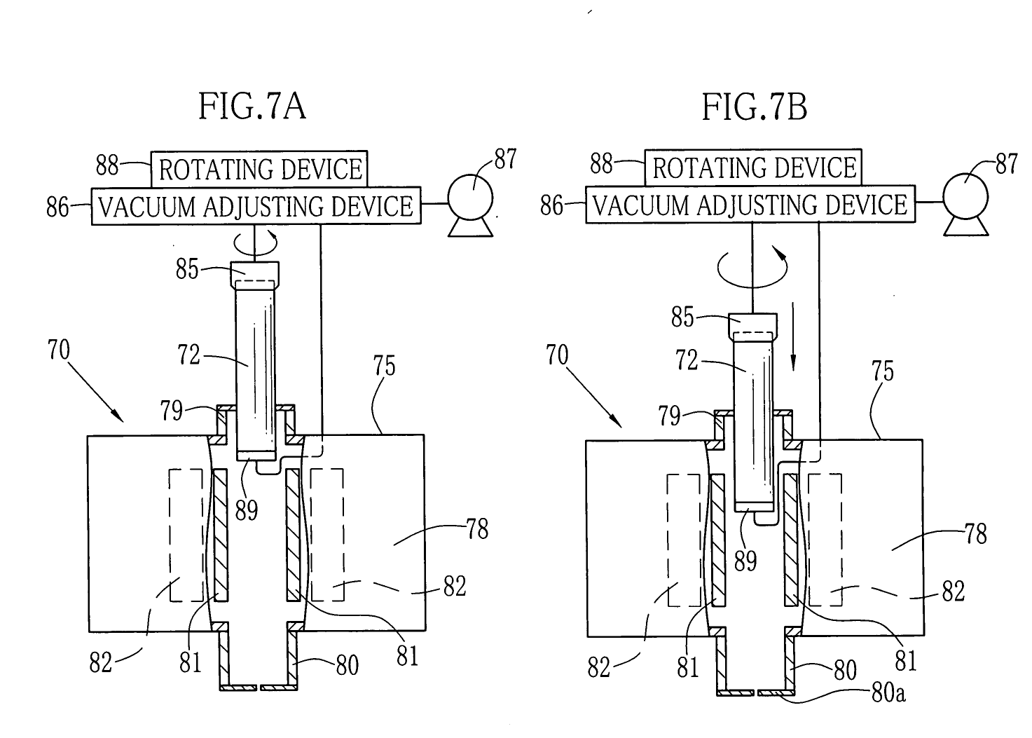

The processes of the drawing of the preform 72 into the POF 71 will be described with reference to FIGS. 6-7C. Note that the same members and the parts have the same numerals as in FIG. 4, and the explanation thereof is omitted.

As shown in FIGS. 6A and 6B, when the preform 72 is set to the melt-drawing device 70, the upper end of the preform 72 is fitted to the upper adapter 85 and the leading portion 72c of the preform 72 is fitted to a lower adapter 89. The upper adapter 85 has a holding member 90 so as to keep the position and the balance of the preform 72 during the performance of the drawing. The preform 72 and the upper adapter 85 are tightly closed by contacting an upper end 72a to a contact surface 91. The upper adapter 85 is provided with suction paths 85a-85g continuing to the gaps 101a-107a, and the suction of gas is made through the suction paths 85a-85g. Further, the preform 72 and the lower adapter 89 are tightly closed by contacting a lower end 72b to a contact surface 92. The lower adapter 89 can be provided with suction paths 89a-89g continuing to the gaps 101a-107a, and the suction of gas can be made through the suction paths 89a-89g.

It is preferable in the preform 72 that the glass transition temperature (Tg; ° C.) becomes gradually lower from the clad tube 110 toward the center rod 101. In heating with the heater 82 under this distribution of the glass transition temperature Tg, the clad tube 110 is heated at first before the core tubes 107-102 are heated, and then the thermal energy is transmitted from the outer side to the inner side to heat the center rod 101 at last. Accordingly, the tubes in the outer side must be formed from the polymers having high glass transition temperature Tg, such that the deformation of the POF 71 or the preform 72 in the high temperature is prevented, and the rod and the tubes in the inner side may be formed from the polymers having low glass transition temperature Tg such that the change of the state occurs in the low temperature. Under such distribution of the glass transition temperature (Tg; ° C.), the preform 72 can be smoothly drawn into the POF 71, and as the tubes and the rod in the inner side can be drawn in the lower temperature, the entire tubes and the rods can be drawn almost uniformly.

Usually, when the different polymers are combined, the combination is selected to have high compatibility. Thus the turbidity of the products is prevented, and the optical permeability does not become lower. Therefore, the loss of the used materials can be made smaller. Accordingly, when the polymers are combined for the production of the preform 72 such that the compatibility may become higher, then the interfacial irregularity does not occur during the performance of the melt-drawing of the obtained preform 72 to the POF 71. Further, the polymers used for the preform 72 are not restricted especially, so far as the glass transition temperature Tg is different between the layers above described. However, when polymers of which the skeletons in the combination for the center rod 101 and the first-sixth core tubes 102-107 are different are used, the interfacial irregularity occurs in the produced POF, in which the transmitted light scatters and the transmission loss becomes larger. Especially, in the core of the POF 71 that corresponds to the center rod 101 and the first-sixth core tubes 102-107, it is extremely important to prevent the interfacial irregularity. Accordingly, it is preferable in the preform 72 that the center rod 101 and the first-sixth core tubes 102-107 are formed from either of homopolymer and copolymer which is composed from the monomer of the homopolymer. The preferable glass transition temperatures of the center rod 101 and the first-sixth core tubes 102-107 are in the range of 10° C. to 60° C., since the neighboring tubes and rods easily contact to each other by the melt-drawing to block occurrence of interfacial irregularity.

As shown in FIG. 7A, the preform 72 is disposed above the heating pipe 81, and the adapters 85, 89 are connected through the vacuum adjusting device 86 to the vacuum pump 87 for sucking the atmosphere in the gaps 101a-107a. Then the rotating device 88 starts rotating the preform 72. The rotational speed is not restricted especially, and may be zero. However, the preferable value thereof is in the range of 0.15 rpm to 30 rpm. The rotation uniformly transmits the thermal energy in the cross section of the preform 72, such that the diameter of the POF 71 may be uniform. Note that the rotation is made too much, a sharing force is applied to break the preform 72.

As the gaps 101a-107a of the preform 72 are connected to the suction paths 85a-85g of the upper adapter 85, the atmosphere in the gaps 101a-107a can be sucked. The suction is effective in removing the foreign materials (mainly low molecular weight compounds) from the center rod 101, the first-sixth core tubes 102-107 and the clad tube 110. Further, in this situation, when the melt-drawing is made, then the center rod 101, the first-sixth core tubes 102-107, and the clad tube 110 become nearer are fused. Thus the POF 71 is obtained not so as to contain the voids in the interface.

Further, as the gaps 101a-107a of the preform 72 are connected to the suction paths 89a-89g of the lower adapter 89, the inner pressure of the gaps 101a-107a can be regulated. In the suction, the volatile components generated from the center rod 101 and the first-sixth tubes 102-107 are sucked from the gaps 101a-107a, and the humidity and the oxygen concentration becomes smaller. Thus in forming the POF 71, the generation of the voids at the interface of each layer and that of the decomposition such as the oxidization and the like are prevented. Note that the preferable inner pressure in the gaps 101a-107a is 80000 Pa to 101000 Pa. However, the present invention is not restricted in this range.

The vacuum adjusting device 86 is provided with a valve and a pressure meter (not shown). In the suction, the inner pressure becomes to a predetermined value by opening and closing the valve on the basis of the measured value of the pressure meter. The sort of the vacuum pump 87 is not restricted. It is not necessary that the vacuum degree is very high. It is therefore preferable that in the preferable vacuum pump 87 plural rotary pumps of oil bath type are arranged in parallel for reduction of the fluctuation. Note that the suction paths 85a-85g may be provided with a trap such that the volatile components don't flow into the preform 72.

Note that the vacuum degree is not restricted, and can be determined in accordance with the pressure, the easiness of deformation of the softened rod and tubes, and the like. Usually, the vacuum degree is determined to the value at which softened tubes can starts shrinking in the suction. Preferably that the inner pressure near the center rod is much smaller than that in the outer side of the preform. In this case, the tubes in the outer side can more easily shrink. Further, the lower limit of the pressure is not restricted. However, it is determined in the value that the production cost does not become too high and the preform 72 is hardly damaged.

When the inner pressure becomes the predetermined value, as shown in FIG. 7B, the preform 72 is partially inserted in the heating pipe 81. The heater 82 heats the preform 72 through the heating pipe 81. Thereby as the preform 72 melts in the rotation, the circularity of the POF 71 can be higher. When the tubes are melted and softened, they shrink toward the center of the preform 72 to adhere or contact to each other in effect of the atmospheric pressure. Accordingly, it is not necessary in the present invention to apply the pressure from the outside to the preform 72. Further, when the gas is generated from the polymer (for example, PMMA and several additives) in the preform, no voids are generated. In the preform 72, as the suction of the gaps 101a-107a is made, the thermal energy is difficult to transmit toward the center. Accordingly, the gaps 101a-107a are preferably smaller.

The melting of the polymer is proceeded until the gaps 101a-107a are diminished in the lower side of the preform 72. Then as shown in FIG. 7C, a cap 80a or lid of the exit portion 80 is removed, and the rotation of the preform 72 is stopped. Thereafter, the connection of the lower adapter 89 to the vacuum adjusting device 86 is released. As shown in FIG. 7D, the lower adapter 89 is moved downwards to draw the preform 72 into a fiber shape.

When the lower adapter 89 is shifted to a predetermined position, as shown in FIG. 4, the leading portion 72c of the POF 71 out of the melt-drawing device 70 is cut. Then the cap 80a is set to the melt-drawing device 70 again, and the winding of the POF 71 starts. Thereafter, it is preferable that the rotation is continuously made by the rotating device 88 so as to make the circularity larger, and that the suction is continuously made by the vacuum pump 87 so as to remove the gas generated from the preform 72 and to reduce the foreign materials. Further, since the cap 80a is set to the melt-drawing device 70, the sudden change of the transmission of the thermal energy is prevented. While the drawing is made as the manner above described, the POF 71 in which the interfacial irregularity is reduced is continuously produced. Note that the diameter of the POF is measured with the monitor 76, and the heating temperature of the heater and the drawing speed are adjusted on the basis of the result of the measurement.

The preferable heating temperature is usually in the range of 180° C. to 250° C. As the POF produced in the present invention has the refractive index distribution in which the refractive index becomes lower from the center toward the outer side, it is necessary to make the uniform heating and drawing in the cross section of the preform, such that the refractive index distribution may be kept. Therefore, the heating pipe may have a cylindrical shape for the uniform heating of the preform in the cross section. Further, the temperature on the inner wall of the heating pipe may not be constant in the drawing direction. It is preferable that the inner wall of the heating pipe may have the temperature distribution in a lengthwise direction, so as to make the melted portion of the preform 72 smaller, because changes in the distribution can be smaller. Concretely, the main heating for melting the preform is made between the previous heating and the annealing in the oven 75, such that the melted portion of the preform may be smaller. Further, the laser beam can be used as a heat source for supplying high energy in a small area. Thus, the predetermined refractive index distribution can be easily provided for the POF 71, and the productivity becomes higher.

In order to keep the linear shape and the circularity, the melt-drawing device 70 is preferably provided with a center positioning device for positioning the center rod of the preform 72 to a predetermined position. Further, the orientation of the polymer in the POF can be regulated by adjusting the drawing conditions. Furthermore, the mechanical properties (bending property of the POF obtained by drawing and the like) and the heat shrinkage can be regulated. Further, as described in Japanese Patent Laid-Open Publication No. 7-234322, the tension for the drawing is at least 0.1 N such that the orientation of the melted plastic may be made, and as described in Japanese Patent Laid-Open Publication No. 7-234324, the tension is at least 1N such that the POF does not have irregular form. Also, as shown in JP-A 8-106015, the pretreatment of heating the optical fiber can be used before the drawing of a preform. Further, as shown in Japanese Patent Laid-Open Publication No. 7-244220, the bending properties and the lateral pressure characteristics can be improved by regulating the elongation at break and the strength of the POF obtained in the above methods. Further, as shown in Japanese Patent Laid-Open Publication No. 8-54521, a low refractive index layer may be formed as a reflecting layer on a periphery of the optical fiber, so as to improve the transmission properties.

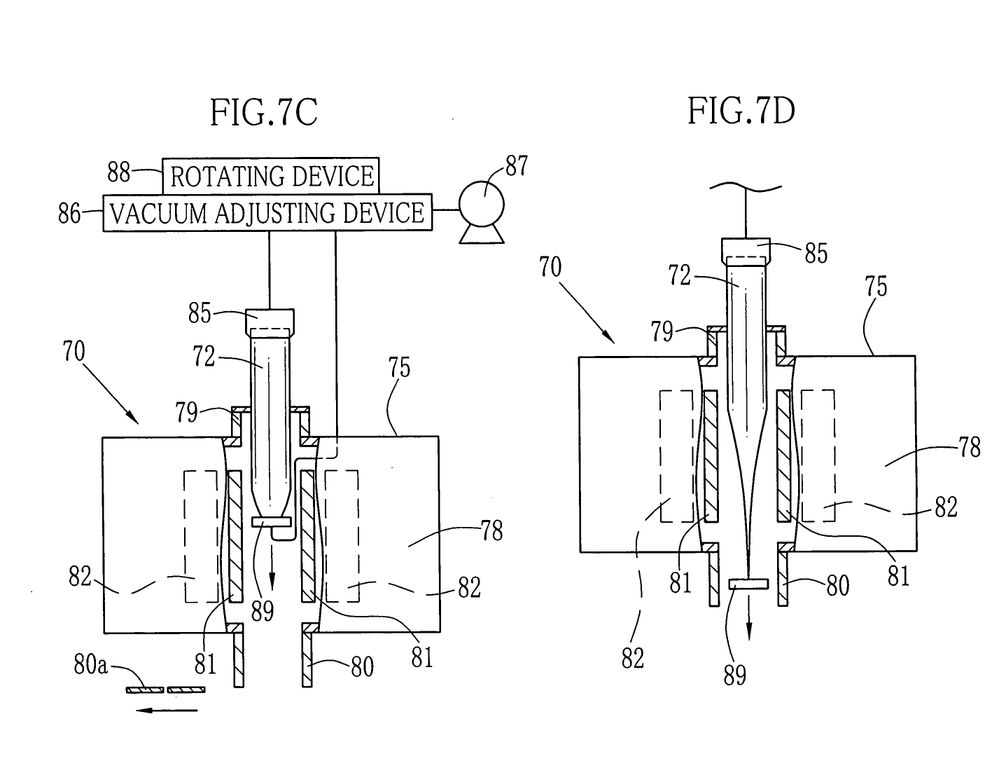

In FIG. 8, the POF 71 has a core constructed of a core center 111 and first-sixth layers 112-117 or regions. Further, the POF 71 has a region of a clad 118 formed on the sixth layer 117. Note that the lines representing the interface of the neighboring layers are illustrated for explanation.

As shown in FIG. 9, the refractive index distribution the POF 71 is the largest at the core center 111 as the center of the core, and becomes lower toward the sixth layer 117 as the outermost sixth layer 117 of the core. Further, in the present invention, the refractive index of the clad 118 is the lowest in the POF 71, is at least 3% lower than the outermost sixth layer 117 of the core, such that the reflectivity at the interface of the core and the clad may be high. In the embodiment of FIG. 9, the ratio of the refractive index of the sixth layer 117 (outermost layer) to the clad 118 is:

(1.403/1.492)×100≅2.8%

As shown in FIGS. 8 & 9, the core center 111 of the POF 71 corresponds to the center rod 101, the first-sixth layers 112-117 of the POF 71 to the first-sixth core tubes 102-107 respectively, and the clad 118 to the clad tube 110. As the preform has the above distributions of the refractivity and the glass transition temperature Tg (° C.), the polymer in the POF 71 is hardly damaged in the melt drawing, and therefore the band characteristics of the light transmitted in the POF 71 is broad.

In the present invention, when there is a relation between the refractive index and the glass transition temperature in the polymer, the materials of the polymer are not restricted. However, the bad compatibility at each interface causes the scatter of the transmitted light. Accordingly, in order to combine the smaller number of polymers, it is preferable to use the polymer in which a refractive index control agent is added to the homopolymer. Otherwise, as the polymer, the copolymer obtained from the several sorts of the monomers is used. In this case, the composition ratio of the monomers are changed in order to adjust the physical properties, such as the refractive index, the glass transition temperature and the like.

Note that when the copolymer is used, the homopolymer composed from one of the monomers as the materials of the copolymer can be also used with the copolymer.

When one sort of the polymer is used, diphenylsulfide (DPS: refractive index 1.63 (liquid)) as the refractive index control agent may be added to PMMA (glass transition temperature is 100° C. to 115° C. (measured with differential scanning calorimeter of thermal compensation type (DSC); refractive index 1.492 (measured with index profiler)). In this case, as the amount of the added DSP is larger, the refractive index of the preform 72 becomes higher, and the glass transition temperature Tg (° C.) becomes lower. When the copolymer is used, PMMA and the polybenzyl methacrylate (Glass transition temperature is 65° C. to 80° C. (measured with differential scanning calorimeter of thermal compensation type (DSC); refractive index 1.568 (measured with index profiler)) are uses as the refractive index control agent. In the present invention, index profiler IP-5500 (produced by SEIKO EG&G Co. Ltd.) is used as the index profiler.

The composition ratio of methylmethacrylate (MMA) and benzylmethacrylate (BzMA) is changed to produce the methylmethacrylate-benzylmethacrylate copolymer (hereinafter MMA-BzMA copolymer). When the composition ratio of BzMA becomes higher in MMA-BzMA copolymer, the glass transition temperature Tg (° C.) becomes lower but the refractive index becomes higher. Accordingly, it is preferable that the center rod 101 is formed from the copolymer of the low composition ratio (desirably about 5 wt. % to 30 wt. %) of BzMA. Further, when the composition ratio of BzMA in the first-sixth core tubes 102-107 are gradually decreased toward the outer side, the refractive index becomes lower and the glass transition temperature Tg becomes higher. Further, it is preferable that the sixth core tube 107 is formed from the copolymer of the low composition ratio (desirably about 0 wt. % to 5 wt. %) of BzMA. Note that the main component of the sixth core tube 107 may PMMA of homopolymer.

The refractive index decreases from the inner side to the outer side in the POF in a manner of nearly squared distribution. In the present invention, when the refractive index coefficient as a coefficient according to the refractive index of the optical fiber is approximated after the power method, then the index for determining the refractive index profile is nearly 2. Accordingly, the refractive index distribution is not the same as the squared distribution, but similar to it. Therefore the meaning of the nearly squared distribution includes several meanings of the continuously or sequentially changing distributions which are similar to squared distribution. The axis of ordinate represents the refractive index, and the transverse axis represents the radial distance from the center of the POF. In this case, when the distance from the center is larger, the refractive index becomes lower substantially symmetrically with the center. Such distribution is determined as the nearly squared distribution in the present invention.

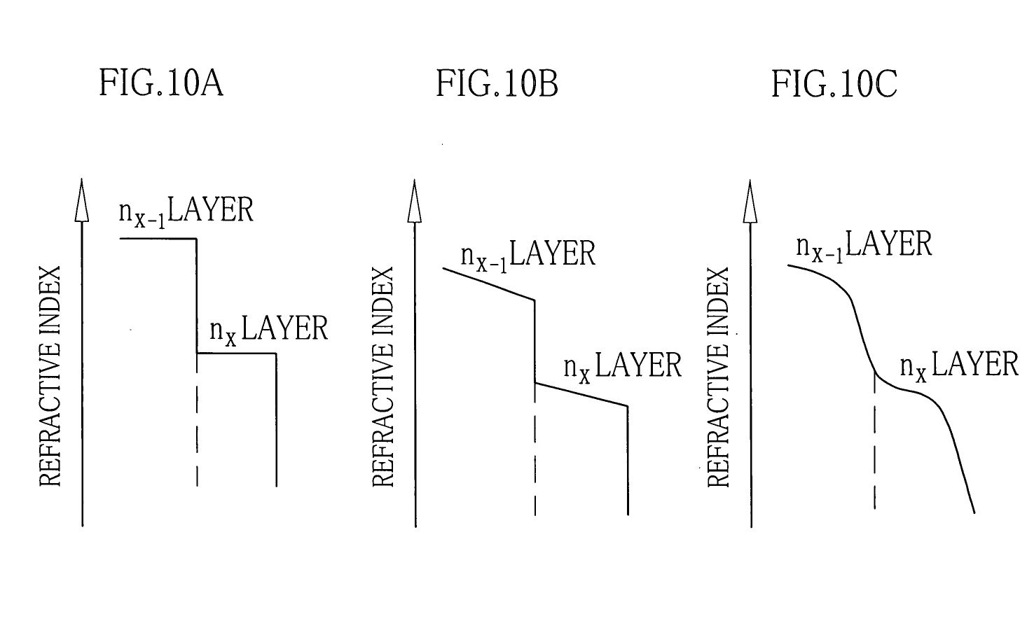

In FIGS. 10A-10C, an nₓ^{th} layer and an nₓ₋₁^{th} layer are neighbored to each other. In the present invention, the refractive index within each layer may be constant (in FIG. 10A), and may change (in FIGS. 10B & 10C). Also, a preferred POF can include one layer within which a refractive index is constant and another layer within whith a refractive index varies with a certain distribution. When the POF has a layer within which the refractive index changes (as shown in FIGS. 10B & 10C), then the number of the layers can be smaller. When it is designated to change the refractive index within the one layer, for example, the conditions of the polymerization are controlled such that the concentration of the refractive index control agent may vary in the one layer, or the refractive index control agent is dispersed by operating, such as heating after the formation of the preform and the polymer rod. Note that when the refractive index control agent moves so much in the dispersion, the predetermined refractive index distribution cannot be obtained, because the distribution of the index changes considerably. Accordingly, when such operation is made, the combination of the polymer and the refractive index control agent must be considered.

In the plastic optical fiber of the present invention, a preferred difference of the refractive indexes between the center portion and outermost portion is at least 0.01 at 20° C. when the light of sodium D line is applied. Further, the difference between the neighboring layers depends on the number of the total layers to be formed. However, the difference is preferably at least 0.01. The thickness of each layer is not restricted so far as the tubes and the rods for forming the layers are not broken in the suction. Further, the thickness of each layer may be constant or different, so far as the refractive index distribution is nearly squared distribution.

<Formation Method of Coating Layer>

The POF produced in the above methods is used as in several ways without any other treatment or processing. Otherwise, a periphery of the POF may be coated with a coating layer to a primary coated optical fiber with fiber or fabric materials for the protection and the reinforcement. Further, an optical fiber cable in which the plural POFs or the plural primary coated optical fibers are bundled is used in several ways. In the coating process, for example, the POF is inserted in a channel of the dies which are confronted to each other, and the two dies are filled with the melted resin for coating, and the POF is drawn to pass through the channel. Thus the primary coated optical fiber is obtained. The coating layer must protect the POF against a stress which occurs when a primary coated optical fiber is bended. Accordingly, it is preferable that the coating layer does not fixedly adhere to the POF. Further, in forming the coating layer, the thermal energy of the melted resin can damage the POF. Therefore it is preferable that the selected resin for the coating layer is melted in a low temperature, or the melted resin flows at a speed to preventing the damage of the POF. In this case, the thickness of the coating layer is determined in accordance with the melting point of the materials for coating, the drawing speed of the POF in the orifices of the dies, and the cooling temperature of the coating layer. In the formation methods of the coating layer, there are several methods of polymerizing monomers which is applied on the POF, of winding a sheet, of inserting the POF into a tube produced with melt extrusion, and the like.

Furthermore, when the POF or the primary coated optical fiber is bundled to the optical fiber cable, then a cable coating is formed. There are two types of the optical fiber cables. The first type is an adhesion type, in which the cable coating contacts to the optical fiber bundle of the POF or the first primary coated optical fiber, and the second type is a loose type, in which there is a space between the cable coating and the optical fiber bundle. In the loose type, when the cable coating is peeled at a contact portion to the connecter, moisture may intrude from the peeled portion into the inside of the optical fiber cable. Accordingly, the adhesion type is preferable.

However, in the loose type, as the cable coating is not adhered to the entire surface of the optical fiber bundle, the influences of the stress or the heat on the optical fiber bundle becomes smaller. Accordingly the damage of the POF is reduced. Therefore, there is an occasional case to use the loose type, depending on the object of use. In order to prevent the intrusion of the moisture, the space between the cable coating and the optical fiber bundle is filled with mills or gel-like semisolid materials having fluidity. Further, when the mills or the semisolid materials have effects for preventing the moisture transference, the cable coating of high quality is formed. When the cable coating of the loose type is formed, the position of the extrusion opening of the cross head dies is adjusted to regulate the decompressing device for forming the space. The thickness of the space is controlled by increasing and decreasing the pressure in the spaces.

Further, a second coating may be formed on the primary coated optical fiber, so as to obtain a secondary coated optical fiber. Accordingly, the secondary coated optical fiber is constructed the POF, the coating layer as a first coating layer provided over the POF. The second coating layer provided over the first coating layer. The second coating layer may contain the additives to the polymer, which are, for example, flame-retardant, UV-stabilizer, antioxidant, radical scavenger, lubricant. These additives may be also contained in the first layer, so far as the first layer does not lose the property of moisture blockage. Note that flame-retardant is resin containing halogen such as bromine and the like, or containing phosphorus. However, recently, it becomes more usual that metal hydroxide is used as the flame-retardant, in view of safety by reduction of toxic gas. In this case, the metal hydroxide contains crystallization water, which is absorbed in the production process. As the water cannot be perfectly removed from the metal hydroxide, it is preferable that the metal hydroxide is contained in the second coating layer.

Further, in order to provide the several effects, several coatings having different effects may be provided over the POF. As these coating layers, for example, a barrier layer for reducing the moisture absorbance, a layer containing moisture absorbing material (for example, a moisture absorbing tape or a moisture absorbing gel), may be provided in the first coating layer or between the first and the second coating layer. Furthermore, layers containing cushioning materials, such as a bendable layer, an expandable layer and the like, may be formed in order to decrease the stress in bending, and an enforcement layer and the like may be formed in order to increase the rigidity. The sort of layers to be formed is selected in accordance with the way of use. When the fiber materials, such as metallic fiber having high rigidity, a fiber having high elastic modulus, a fiber having high tensile strength, and the like are contained in the polymer or the plasticity resin, the mechanical strength of the obtained optical fiber cable is reinforced.

As the high tensile strength fiber, there are aramid fiber, polyester fiber, polyamide fiber and the like. As the metallic fiber, there are stainless fiber, zinc alloy fiber, copper fiber and the like. However, the sorts of these fibers are not restricted in them. Further, in order to prevent the damage of the POF, the metallic pipes may be provided around the optical materials, such as the optical fiber bundle or the optical fiber cable, or the like, a support line may be provided along them, and otherwise a machine or a mechanism may be used for increasing the workability in wiring the optical materials.

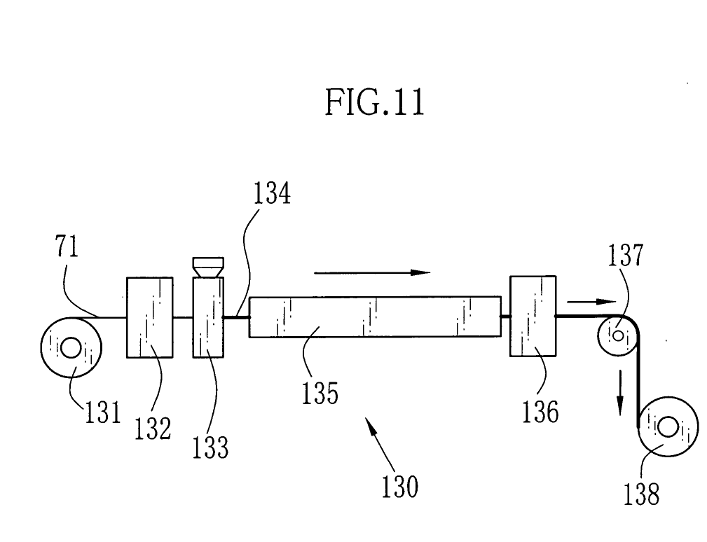

The method of producing a primary coated optical fiber from the POF 71 is explained with reference to FIG. 11. As a coating line for coating the POF 71 with the first coating layer, the already know coating line for coating an electric cable or a quartz optical fiber is used. In a coating line 130, the POF 71 is unwound by an unwinding machine 131, and fed to a cooling apparatus 132, in which the POF 71 is cooled at 5° C. to 35° C. The cooling of the POF 71 is preferable in order to reduce the damage thereof. However, the cooling apparatus 132 may be omitted.

Then, a coating machine 133 coats the POF 71 with a coating material to obtain a primary coated optical fiber 134. The primary coated optical fiber 134 is cooled with a cooing water in a water bath 135, and thereafter the remaining water on the primary coated optical fiber 134 is removed with a dryer or desiccator 136. Note that the method of cooling of the primary coated optical fiber 134 is not restricted in using the water bath, and another device may be used. Further, the primary coated optical fiber 134 is transported with the rotation of a roller 137, and wound by a winding machine 138. Note that the unwinding of the POF 71 is made in this figure. However, the present invention is not restricted in it.

Further, in accordance with the way of use, the primary coated optical fiber 134 is selectively used is in a cable assembly in which the primary coated optical fiber 134 is circularly arranged, a tape core wire in which the primary coated optical fiber 134 is linearly aligned, and a cable assembly in which the tape core wires are bundled with a band, a lap sheath or the like, and so on.

Further, the optical fibers in which the POFs of the present invention are used may be conjugated by the matching, since having higher axial offset tolerance than the prior optical fiber. However, it is preferable that a connecter is provided at an end of each optical fiber, and the optical fibers are connected by fixing the connecting portions. As the connecter usually known, there are several types, such as PN type, SMA type, SMI type, F05 type, MU type, FC type, SC type and the like.

There are several systems for transmitting the optical signals, in which are used the optical members of the present invention, such as the POF, the primary coated optical fiber, the optical fiber cord, the optical fiber cable and the like. The system is constructed of an optical signal processing device which includes optical members and parts, such as a light emitting element, a light receiving element, an optical switch, an optical isolator, an optical integrated circuit, an optical transmitter and receiver module, and the like. Further, another type of the optical fiber and the like may be used in the system, if necessary. In this case, any known techniques can be applied to the present invention. The techniques are described in, for example, “‘Basic and Practice of Plastic Optical Fiber’ (issued from NTS Inc.)”, “‘Optical Parts can be Loaded on Printed Wiring Assembly, at Last’ in Nikkei Electronics, issued on Dec. 3, 2001”, Pages 110-127”, and so on. When the present invention is combined with the techniques in these publications, then the optical members are used for the wiring in apparatuses (such as computers and several digital apparatuses), the wiring in the vehicles and vessels, the linking between optical terminals and the digital device, and between the digital devices. Further, in the combination of the present invention with the above techniques, the optical members may be applied to the optical transmitting system adequate for optical transmission in short distance, for example, for data communication of large capacity, for use of control without influence of the electromagnetic wave. Concretely, the optical members produced in the present invention are applied to the optical LAN in each of or the optical LAN between houses, collective housings, fabrics, offices, hospitals, schools in an area, or the optical LAN in each of them.

Further, the other techniques to be combined are disclosed, for example, in “‘High-Uniformity Star Coupler Using Diffused Light Transmission’ in IEICE TRANS. ELECTRON., VOL. E84-C, No.3, MARCH 2001, p.339-344”, “‘Interconnection in Technique of Optical Sheet Bus’ in Journal of Japan Institute of Electronics Packaging., Vol.3, No.6, 2000, p.476-480”. Further, in the other techniques, there are a light bus (disclosed in Japanese Patent Laid-Open Publications No.10-123350, No.2002-90571, No.2001-290055 and the like); an optical branching/coupling device (disclosed in Japanese Patent Laid-Open Publications No.2001-74971, No.2000-329962, No.2001-74966, No.2001-74968, No.2001-318263, No.2001-311840 and the like); an optical star coupler (disclosed in Japanese Patent Laid-Open Publications No.2000-241655); a device for optical signal transmission and a light data bus system (disclosed in Japanese Patent Laid-Open Publications No.2002-62457, No.2002-101044, No.2001-305395 and the like); a processing device of optical signal (disclosed in Japanese Patent Laid-Open Publications No.2000-23011 and the like); a cross connect system for optical signals (disclosed in Japanese Patent Laid-Open Publications No.2001-86537 and the like); a light transmitting system (disclosed in Japanese Patent Laid-Open Publications No.2002-26815 and the like); multi-function system (disclosed in Japanese Patent Laid-Open Publications No.2001-339554, No.2001-339555 and the like); and several sorts of waveguides, optical branching, optical couplers, optical multiplexers, optical demultiplexers and the like. When the present invention is combined with these techniques, the optical members produced in the present invention are used in a system of the optical transmission of high grade, in which the signal is multiply sent and received, and otherwise used for lighting, energy transmission, illumination, and sensors.

<Experiment>

The experiment of the optical fiber of the present invention was made. In the experiment, an example and a comparison of the optical fiber were produced. At first, the explanation of the example is made in detail. Then the explanation of the comparison follows, and that of the same parts as the example will be omitted. The materials, contents, operations and the like will be changed so far as the changes are possible in the present invention. Accordingly, the present invention is not restricted in the following Experiment.

In Example, methylmethacrylate (MMA), benzylmethacrylate (BzMA) which were refined were used as the monomer. Further, di-t-butylperoxide (PBD) was used as the polymerization initiators, and n-laurilmercaptan (n-LM) was used as the chain transfer agent. These materials are polymerized to MMA-BzMA copolymer or PMMA, which were later used for forming the core of the optical fiber. Further, PVDF (polyvinylidenefluoride) having refractive index of 1.403 was used for forming the clad of the optical fiber.

(Producing Method of Center Rod)

The refined MMA and BzMA as the materials of the polymers were supplied in a reaction vessel and mixed, such that weight ratio of them in the mixture was MMA:BzMA=0.80:0.20. Then, PBD (the polymerization agent) and n-LM (the chain transfer agent) were supplied to the reaction vessel, such that the contents thereof to 100 pts.wt. of the polymer materials were respectively 0.013 wt. % and 0.27 wt. %. Thus the polymerization was performed. After the polymerization, part of the polymer (MMA-BzMA copolymer) was sampled. Then the refractive index (n_{d}) and the averaged molecular weight (Mwₐᵥ) thereof were measured. The results of the measurement were: n_{d=}1.507, and Mwₐᵥ=60000. Further, the melt flow index was measured, and the value thereof was 6 g/(10 min) at 230° C. Further, the glass transition temperature Tg was measured with the differential scanning calorimeter of thermal compensation type (DSC), and the value thereof was 104.4° C.

The center rod 101 (see FIG. 5) was made of MMA-BzMA copolymer in melt-extrusion method with use of the production line 30 as shown in FIG. 2. The MMA-BzMA copolymer was supplied in the hopper 36, and extruded at 200-220° C. from the extruding die 32 to the molding die 33 at 0.5 m/min so as to have the outer diameter of 8 mm. Thus the extrusion was made not to form the unevenness on the periphery of the solidified polymer. Thereafter, it was cooled by the cooling device 34, and dried enough by a drying device (not shown). Thus the center rod 101 for the preform 72 was obtained. Then outer diameters at five positions were measured, and their average was calculated. The surface roughness of the outer surface was measured with the laser displacement meter for measurement of surface shape VK-8500 produced by Keyence Corporation. Thereby the magnification power of the objective lens was 50×. The measurement of the surface roughness was made by scanning the He—Ne laser beam. The surface roughness (SRa) per unit area was 0.2211 μm.

(Producing Method of Core Tube)

The first-sixth core tubes 102-107 whose surfaces were adequate were formed with the innersizing die type of the melt-extruding machine in FIG. 1. The composition ratio of the MMA and BzMA was changed (see Table 1), and the MMA-BzMA copolymer was prepared. Other conditions for polymerization were the same as in making the center rod. Thereafter, the core tubes were formed from the copolymers so as to have the respectively predetermined outer surfaces and the wall thickness. Note that the composition ratio of MMA/BzMA, the refractive index and the glass transition temperature Tg of the copolymer, the surface roughness of the inner and outer surfaces of the formed core tube are shown in Table 1.

(Producing Method of Clad)

The clad tube was formed from PVDF (KF-#850, melting point: 177° C., produced by Kureha Chemical Industry Co. Ltd.) with use of the die body 13 from 170° C. to 220° C. in the melt-extrusion method, so as to have averaged outer diameter (calculated as in the core tubes) of 65 mm, wall thickness (average of five positions) of 2 mm. The refractive index was 1.403, the glass transition temperature Tg was measured with a measuring method of kinematic viscoelasticity (warm-up velocity of 2° C./min, 10 Hz), and the value thereof was −13° C. The surface roughness of the inner surface was 0.361 nm, and that of the outer surface was 0.459 nm.

The melt flow rate (melt flow index) was 1 g/(one minute) to 6 g/(ten minutes) at 230° C. In the oven 75 of the melt-drawing device 70, the temperature of the melted portions of the core tubes was 200° C. to 220° C., and the pressure in the oven 75 was kept at a pressure lower by 0.025 MPa to 0.05 MPa than the atmospheric pressure. The rotary speed was 0.1 rmp. Under these conditions, the drawing was made slowly. The melting of the preform started. When the melted portion had plasticity, the lower adapter 89 was drawn downwards slowly. Simultaneously, it was checked that the outside atmosphere did not intrude into the spaces, and that the space or void causing the variation of the wire diameter did not remain. Then the lower adapter 89 was removed, and a lower end portion of the drawn fiber was set to the winding device for winding. The obtained POF had the diameter at 0.56 mm and the refractive index distribution as in FIG. 6. Finally, the averaged outer diameter of the POF 71 was 0.58 mm. As shown FIG. 12, the POF was coated with the coating layer of black polyethylene (thickness at 0.8 mm). Thus the primary coated optical fiber 134 was obtained. Then the transmission loss was measured, and the value thereof was 230 dB/km in transmission of the light beam at 650 nm, and 3700 dB/km in transmission of the light beam at 850 nm.

TABLE 1

| | | R. | | | |
|---|---|---|---|---|---|
| | W. Ratio of | Index | G.T. Temp. | SRaᵢₙₙ | SRaₒᵤₜ |
| | MMA/BzMA | n_{d} | Tg (° C.) | (μm) | (μm) |
| Center Rod | 0.80/0.20 | 1.507 | 104.4 | — | 0.221 |
| 1^{st} Core Tube | 0.82/0.18 | 1.506 | 105.0 | 0.222 | 0.248 |
| 2^{nd} Core Tube | 0.83/0.17 | 1.505 | 105.3 | 0.236 | 0.227 |
| 3^{rd} Core Tube | 0.86/0.14 | 1.503 | 106.1 | 0.241 | 0.299 |
| 4^{th} Core Tube | 0.90/0.10 | 1.500 | 107.4 | 0.295 | 0.310 |
| 5^{th} Core Tube | 0.95/0.05 | 1.496 | 108.9 | 0.307 | 0.311 |
| 6^{th} Core Tube | 1/0 | 1.492 | 110.5 | 0.350 | 0.353 |
| Clad tube | PVDF Resin | 1.403 | −13 | 0.361 | 0.495 |

W. Ratio: Weight Ratio
R. Index: Refractive Index
G.T. Temp.: Glass Transition Temperature
SRaᵢₙₙ: Surface Roughness of Inner Surface
SRaₒᵤₜ: Surface Roughness of Outer Surface

[Comparison]

In the comparison, the suction was not performed in the melt-drawing. Other conditions were the same as in Example. In the optical fiber of comparison, the spot and the fluctuation of the wire diameter were recognized. Therefore the optical fiber of comparison could not used as the production.

Various changes and modifications are possible in the present invention and may be understood to be within the present invention.

What is claimed is:

1. A method of producing a plastic optical fiber, comprising steps of:
constructing a preform in which first-N^{th} tubes formed from plastic are coaxially disposed, said first tube being positioned innermost, said N^{th} tube being positioned outermost;
heating said preform; and
during the heating, performing a melt-drawing of said preform so as to obtain said plastic optical fiber.

2. A method claimed in claim 1, wherein said plastic optical fiber is constructed of a core and a clad, said core is formed from said first-(N−1)^{th} tubes, and said clad is formed from said N^{th} tube.

3. A method claimed in claim 2, wherein said refractive indexes become lower gradually in the order from said first tube to said N^{th} tube.

4. A method claimed in claim 3, wherein a rod made from plastic is disposed inside said first tube, and has a higher refractive index than said refractive indexes of said first-N^{th} tubes.

5. A method claimed in claim 4, wherein said refractive index of said first-N^{th} tubes decreases from center in a manner of nearly squared distribution.

6. A method claimed in claim 3, wherein a refractive index of said clad is at least 3% lower than a refractive index of outermost part of said core.

7. A method claimed in claim 6, wherein said first-(N−1)^{th} tubes have a same thickness, and said N^{th} tube has a largest thickness.

8. A method claimed in claim 3, further comprising decompressing in gaps formed between neighboring ones of said first-N^{th} tubes in said melt-drawing.

9. A method claimed in claim 8, wherein the decompressing is controlled for making more in inner gaps.

10. A method claimed in claim 9, wherein said preform is rotated in the step of said melt-drawing.

11. A method claimed in claim 3, wherein said plastic material contains polymers to which at least one of (meth)acrylic acid and esters thereof as monomer is polymerized.

12. A method claimed in claim 12, wherein glass-transition temperatures of said tubes become larger gradually from said first tube to said N^{th} tube.

13. A method claimed in claim 12, wherein an averaged surface roughness (SRa) per unit area of each of said tubes is at most 1 μm.

14. An apparatus for producing a plastic optical fiber from a preform in which plural tubes are coaxially disposed, comprising:
a sucking device for sucking gas in gaps formed between said neighboring tubes;
a heating device for heating and gas said preform;
a melt-drawing device for melt-drawing said melted preform.

15. An apparatus claimed in claim 14, wherein said heating device is a furnace in which said preform is disposed so as to extend vertically, and said sucking device sucks said gas from an upper side of said preform in said furnace.

16. An apparatus claimed in claim 15, wherein said sucking device further sucks said gas from a lower side of said preform in said furnace.

17. An apparatus claimed in claim 15, further comprising a rotating device for rotating said preform.

18. An apparatus claimed in claim 17, wherein refractive index is the largest in an innermost tubes among said plural tubes, and becomes lower toward an outside.

19. An apparatus claimed in claim 18, wherein said preform further has a pillar rod which is disposed inside said innermost tube and has large refractive index.
